(19) United States
(12) Patent Application Publication
(10) Pub. No.: US 2026/0094982 A1
(43) Pub. Date: Apr. 2, 2026

(54) Rotating Wedge Connectors

(71) Applicant: Hubbell Incorporated, Shelton, CT (US)

(72) Inventors: Connor Owen Douglas Buckley, Manchester, NH (US); Bradley Steven Elliott, Epping, NH (US); Brian Royal Ellis, Dover, NH (US)

(21) Appl. No.: 19/319,278

(22) Filed: Sep. 4, 2025

Related U.S. Application Data
(60) Provisional application No. 63/691,583, filed on Sep. 6, 2024.

(51) Int. Cl. H01R 4/50

(52) U.S. Cl. CPC H01R 4/5008

(57) ABSTRACT

An electrical cable connector assembly includes a frame having opposing conductor securing contact sections and a cam member rotatably mounted to the frame between the opposing conductor securing contact sections. The cam member includes contact surfaces for contacting the conductors to be secured in the opposing conductor securing contact sections and when the cam member is rotated, the contact surfaces press against the conductors securing the conductors in the opposing conductor securing contact sections.

### CROSS-REFERENCE TO RELATED APPLICATIONS

This application is based on and claims priority to U.S. Provisional Application Ser. No. 63/691,583 filed Sep. 6, 2024 entitled ROTATING WEDGE CONNECTORS the contents of which are incorporated herein in their entirety by reference.

### TECHNICAL FIELD

The present disclosure relates generally to electrical connectors. More particularly, the present disclosure relates to rotating wedge connectors.

### DESCRIPTION OF THE RELATED ART

Wedge type electrical connector assemblies are known in the art. Electrical connectors may be adapted to electrically and mechanically connect conductors within various types of systems. Various types of connector systems exist including various systems utilizing wedge type connectors. For example, a first wedge type connector system includes a C-shaped body having a curved top wall adapted to fit over a first conductor. A bolt-operated wedge is carried by the bottom of the C-shaped body and may include an elongated recess in the top for supporting the second conductor. A conductor interface has a handle thereon which allows the interface to be placed within the C-shaped connector body between the conductors. A bolt positively moves the wedge both in and out of the C-shaped body so that the clamping action of the connector can be tightened or loosened as desired. A second wedge type connector system includes a C-shaped body having a curved top wall adapted to fit over a first conductor and a curved opposing wall adapted to fit over a second conductor. A wedge is set between the first conductor and second conductor after they have been positioned within the C-shaped body. A specialized tool is temporarily attached to the C-shaped body. The specialized tool includes a mechanism for firing an explosive charge which drives a movable pin against the wedge forcing the wedge against the two conductors locking them in place in the C-shaped body.

However, the conductor interface used in the first wedge type connector system described above is generally a separate component of such wedge type electrical connector assembly which requires additional steps and care be taken in order to install the wedge type electrical connector assemblies. The explosive charge utilized in the second wedge type connector system described above is generally noisy and messy to operate and requires specialized tools and the use of explosive charges.

A need exists for a system of connecting conductors which does not require any specialized tooling and which is user friendly and easy to use.

### SUMMARY OF THE INVENTION

The present disclosure provides exemplary embodiments of electrical connector assemblies adapted to electrically and mechanically connect conductors.

According to an illustrative embodiment of the present disclosure, an electrical cable connector assembly includes a frame having opposing conductor securing contact sections and a cam member rotatably mounted to the frame between the opposing conductor securing contact sections. The cam member includes contact surfaces for contacting the conductors to be secured in the opposing conductor securing contact sections and when the cam member is rotated, the contact surfaces press against the conductors securing the conductors in the opposing conductor securing contact sections.

In an exemplary embodiment, the electrical connector assembly includes a substantially C-shaped frame having opposing conductor securing channels and a cam member rotatably mounted to the frame between the opposing conductor securing channels. The cam member includes contact surfaces for contacting the conductors to be secured in the opposing conductor securing channels and when the cam member is rotated, the contact surfaces press against the conductors securing the conductors in the opposing conductor securing channels.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1A is a front view of an electrical cable connector assembly according to an illustrative embodiment of the present disclosure;

FIG. 1B is a perspective view of the electrical cable connector assembly according to an illustrative embodiment of the present disclosure;

FIG. 2 is a side end view of an electrical cable connector assembly according to an illustrative embodiment of the present disclosure;

FIG. 3 is an exploded view of an electrical cable connector assembly according to an illustrative embodiment of the present disclosure;

FIG. 4 is a side view of a pin used for securing a cam member to a frame according to illustrative embodiments of the present disclosure;

FIG. 5 is a perspective view of the frame forming a portion of the electrical cable connector assembly according to illustrative embodiments of the present disclosure;

FIG. 6A is a cross-sectional view of the electrical cable connector assembly depicted in FIG. 1B taken along lines 6A-6A of FIG. 1B according to an illustrative embodiment of the present disclosure;

FIG. 6B is an enlarged view of a portion of the electrical cable connector assembly according to an illustrative embodiment of the present disclosure.

FIG. 7 is a front view of an electrical cable connector assembly according to another illustrative embodiment of the present disclosure;

FIG. 8A is a front view and FIG. 8B is a perspective view of a cam member according to another illustrative embodiment of the present disclosure;

FIG. 9 is a front view of an electrical cable connector assembly according to another illustrative embodiment of the present disclosure;

FIG. 10 A is a front view of an electrical cable connector assembly according to another illustrative embodiment of the present disclosure;

FIG. 10B is a perspective view of an electrical cable connector assembly according to another illustrative embodiment of the present disclosure

FIG. 11 is a front view of a cam member according to another illustrative embodiment of the present disclosure; and

FIG. 12 is a front view of a cam member according to another illustrative embodiment of the present disclosure.

### DETAILED DESCRIPTION

The present disclosure provides exemplary embodiments of improved electrical cable connectors adapted to electrically and mechanically connect conductors within transmission or distribution circuits. The electrical cable connector according to an illustrative embodiment of the present disclosure includes one or more cam members mounted to a C-shaped body. When rotated, the cam member(s) urge the first conductor and the second conductor into the C-shaped body securing them in place. For ease of description, the electrical cable connectors contemplated by the present disclosure may also be referred to herein as the “connectors” in the plural and the “connector” in the singular. The cam members contemplated by the present disclosure may also be referred to herein as the “cam members” in the plural and the “cam member” in the singular. The conductors or cables referenced herein may include single strand or multi strand cables. The conductors or cables may be ground cables which are generally bare cables. Alternatively, the cables may be encased in an insulating jacket or have one or more insulating coatings portions of which are removed prior to placing in the connectors described herein. Reference to stripped or bare conductors or cables refers to portions of the conductors or cables not having the insulating jacket or coatings

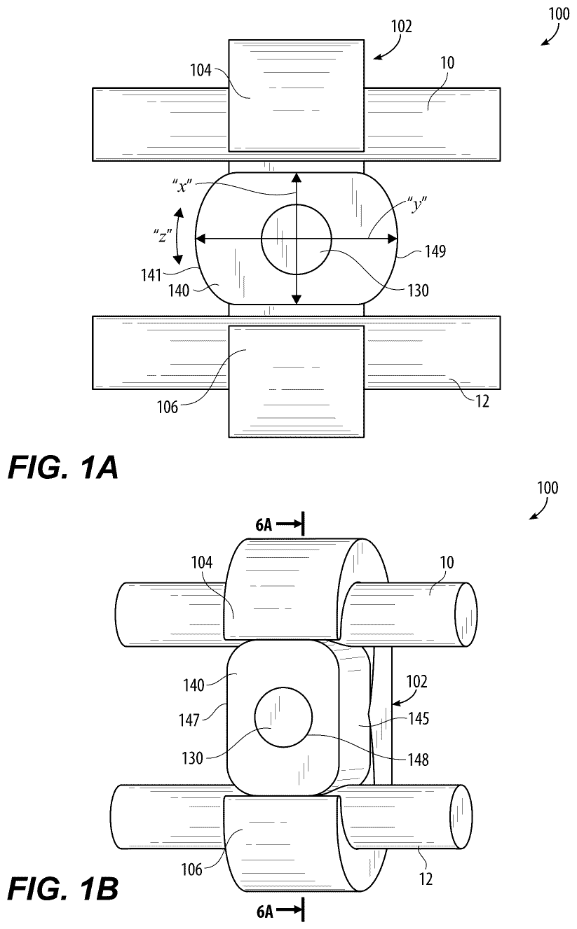

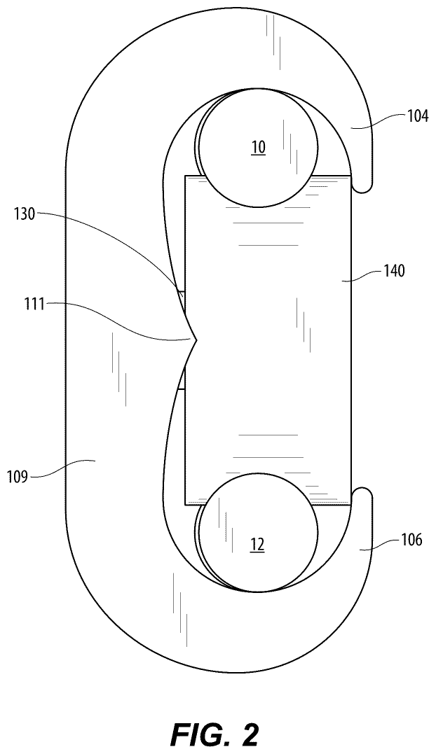

An electrical cable connector according to an illustrative embodiment of the present disclosure is shown in FIGS. 1-6 and may be referred to generally as cable connector or connector 100. Connector 100 includes a generally C-shaped frame 102 having an upper channel 104 and a lower channel 106 which extend from rear portion 109 as seen in FIG. 2. Upper channel 104 and lower channel 106 are dimensioned for receiving stripped or bare cables 10 and 12, respectively, which are to be electrically and mechanically connected. Upper channel 104 and lower channel 106 may be dimensioned to receive cables of a particular size or gauge. Alternatively, upper channel 104 and lower channel 106 may be dimensioned to receive cables of various sizes or gauges. Connector 100 also includes a cam member 140 rotatably mounted by a pin 130 to the rear portion 109 of C-shaped frame 102.

According to the present embodiment, when cam member 140 is in the position depicted in FIG. 2, cable 10 can be readily positioned within upper channel 104 and cable 12 can be readily positioned within lower channel 106. Using a common tool such as, for example, a wrench or pair of pliers, cam member 140 can then rotated in the clockwise or counterclockwise direction (“Z”) from the horizontal position depicted in FIG. 1A to the vertical locked position depicted in FIG. 1B. In the locked position depicted in FIG. 1B, cables 10 and 12 are compressed between cam member 140 and the upper channel 104 and lower channel 106, respectively, thus providing a solid mechanical and electrical connection for cable 10 in the upper channel and cable 12 in the lower channel.

According to the illustrative embodiment depicted in FIGS. 1-6, upper channel 104 and lower channel 106 of C-shaped frame 102 are dimensioned to receive cables of various diameters or gauges. The rear portion 109 of C-shaped frame 102 may be generally flat. However, according to the present illustrative embodiment, the inside rear portion 109 of C-shaped frame 102 rises to form a raised point 111. Cam 140 will rest on this raised point 111. In particular, only a small portion of the rear surface of cam 140 rests on the raised point 111. This allows the rest of the rear surface of cam 140 to be distanced from the surface of rear portion 109 of C-shaped frame 102 as shown in FIG. 2 providing less friction and allowing the cam 140 to be more easily rotated into position by the end used.

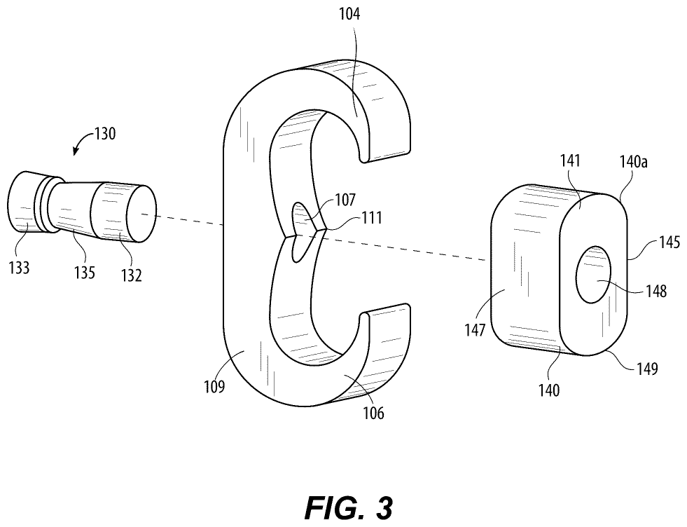

According to an illustrative embodiment of the present disclosure, at least a portion of cam member 140 is generally oblong in cross-section as shown in FIG. 1. For example, as depicted in FIG. 1, cam member 140 is generally wider in the “Y” direction than in the “X” direction. According to the present illustrative embodiment as depicted in FIG. 3, side portions 145 and 147 of cam member 140 are generally flat. Side portions 141 and 149 may be rounded off as shown. Cam member 140 has an orifice 148 extending therethrough which is dimensioned to receive a portion of mounting pin 130 as will be described below.

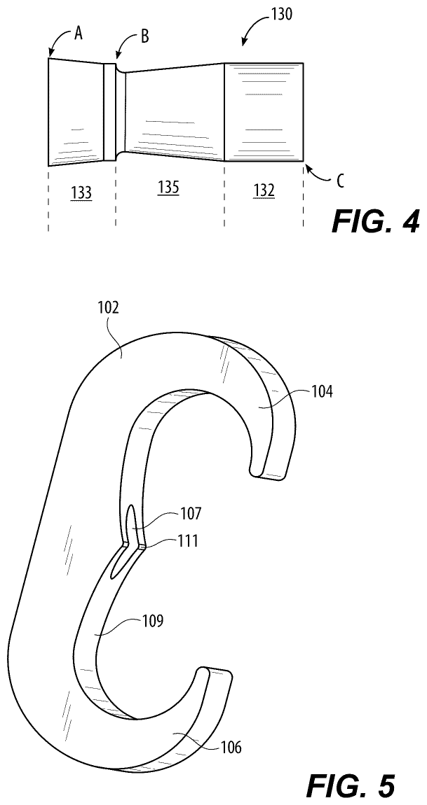

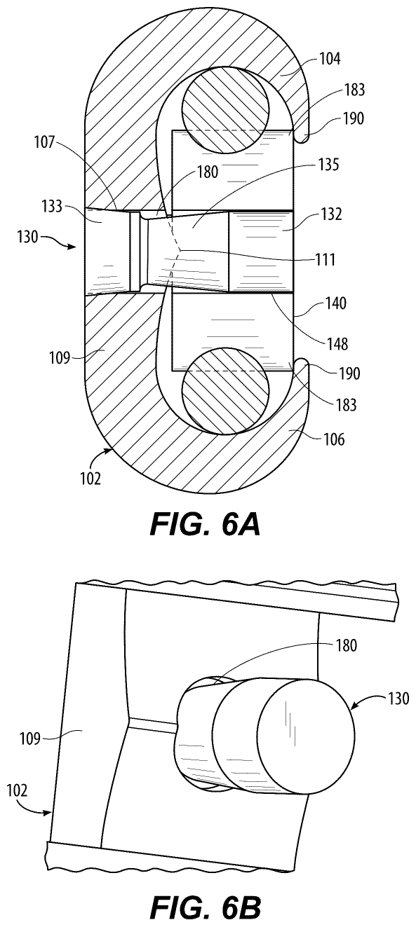

As shown in FIGS. 4, 6A and 6B, pin 130 generally includes three sections. Proximal end section 133 tapers downward from location A to the start of mid-section 135 location B. Mid-section 135 then tapers up toward distal end section 132. Distal end section 132 is generally straight with no taper. However, distal end section 132 may include a slight downward taper extending from its free end to mid-section 135. Alternatively, distal end section 132 may include a slight downward taper extending from mid-section 135 to its free end location C.

The diameter of distal end section 132 of pin 130 is dimensioned to pass relatively easily through orifice 107 in the rear portion 109 of C-shaped frame 102. Pin 130 is passed relatively easily through orifice 107 up to the tapered proximal end 133. Pin 130 may then be press fit further unto orifice 107 until pin 130 is flush with the outer surface of rear portion 109 as shown in FIG. 6A. As shown in FIGS. 6A and 6B, proximal end section 133 of pin 130 only extends part way through the orifice 107 in C-shaped frame 102, forming a gap 180 between the inside surface of orifice 107 and mid-section 135 of pin 130. As further depicted in FIG. 6A, distal end section 132 and a portion of mid-section 135 extend through the orifice 148 in cam member 140. As shown, the tapered mid-section 135 of pin 130 extends into the cam member 140, allowing the cam member 140 to have some movement within the C-shaped frame 102 making it easier to rotate the cam member 140 about the pin 130. As shown in FIG. 6A, the upper outside portion 183 of cam member 140 abuts the inside portions of tip ends 190 of C-shaped frame 102 securing the cam member 140 within C-shaped frame 102.

It will be appreciated that by selecting the diameters for portions of the pin 130 and the diameters of corresponding portions of the orifices in C-shaped frame 102 and cam member 140, the cam member 140 can be made easily rotatable. For example, the proximal end section 133 of pin 130 may be dimensioned to be rotatable within the orifice 107 in C-shaped frame 102. In addition, or alternatively, distal end section of pin 130 may be dimensioned to be rotatable within the orifice 148 in cam member 140.

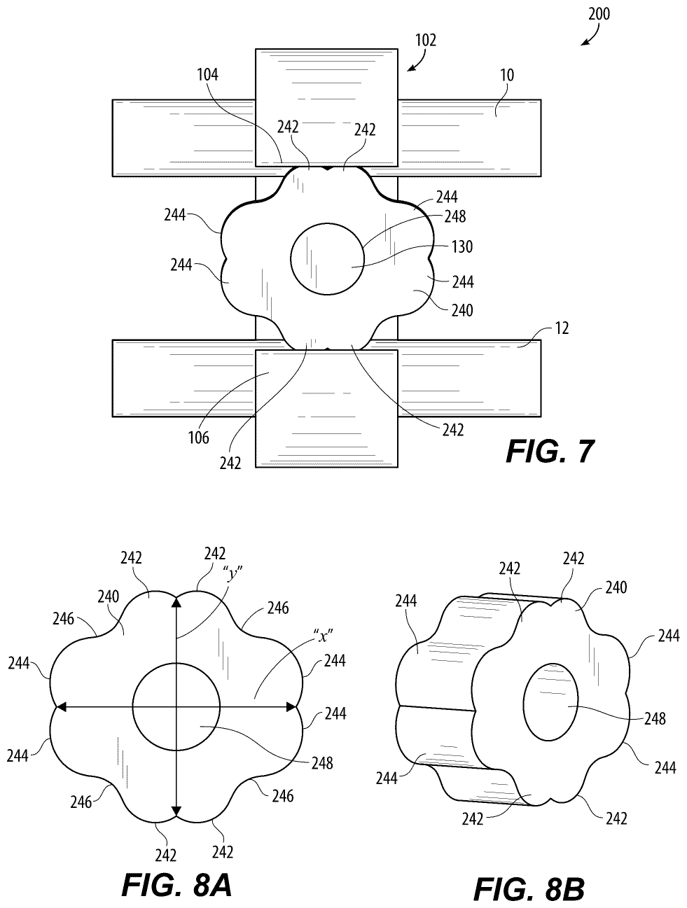

An electrical cable connector according to another illustrative embodiment of the present disclosure is shown in FIGS. 7, 8A and 8B and may be referred to generally as cable connector or connector 200. Connector 200 includes a C-shaped frame 102 which is similar to that described above with respect to FIGS. 1-6. For example, C-shaped frame 102 has an upper channel 104 and a lower channel 106 which extend from rear portion 109. Upper channel 104 and lower channel 106 are dimensioned for receiving stripped or bare cables 10 and 12, respectively, which are to be electrically and mechanically connected. Upper channel 104 and lower channel 106 may be dimensioned to receive cables of a particular size or gauge. Alternatively, upper channel 104 and lower channel 106 may be dimensioned to receive cables of various sizes or gauges. Connector 200 also includes a cam member 240 which is rotatably mounted by a pin 130 to the rear portion 109 of C-shaped frame 102. Cam member 240 has an orifice 248 extending therethrough which is dimensioned to receive a portion of mounting pin 130 similar to the previously described embodiments.

Cam member 240 has a clover leaf shape and is wider in the “X” direction than in the “Y” direction as depicted in FIG. 8A. Cam member 240 is designed for securing cables having various diameters or gauges. For example, cables having a first diameter or gauge may be secured by rotating cam member 240 such that leaves 242 extending from cam member 240 are positioned extending up compressing cable 10 and extending down compressing cable 12, as depicted in FIG. 7. For connecting cables having a second diameter or gauge smaller than the first diameter or gauge, cam member 240 can be rotated such that adjacent leaves 244 extending from cam member 240 are positioned extending up compressing cable 10 and extending down compressing cable 12. It will be appreciated that the outermost portions of adjacent leaves 242 together form a “flat” surface for the cables 10, 12 to rest upon and prevent the cam member 240 from rotating out of position. Similarly, the outermost portions of adjacent leaves 242 together form a “flat” surface for the cables 10 and 12 to rest upon and prevent the cam member 240 from rotating out of position.

According to the present embodiment, in order to position cables within connector 200, cam member 240 is rotated so that valleys 246 of cam member 240 are positioned adjacent the upper and lower channels 104 and 106, respectively. The cables 10 and 12 can then be easily placed within the upper and lower channels 104 and 106 and the cam member 240 rotated in the appropriate clockwise or counterclockwise direction, depending on which of the leaves (242 or 244) are to be used to secure the cables 10 and 12.

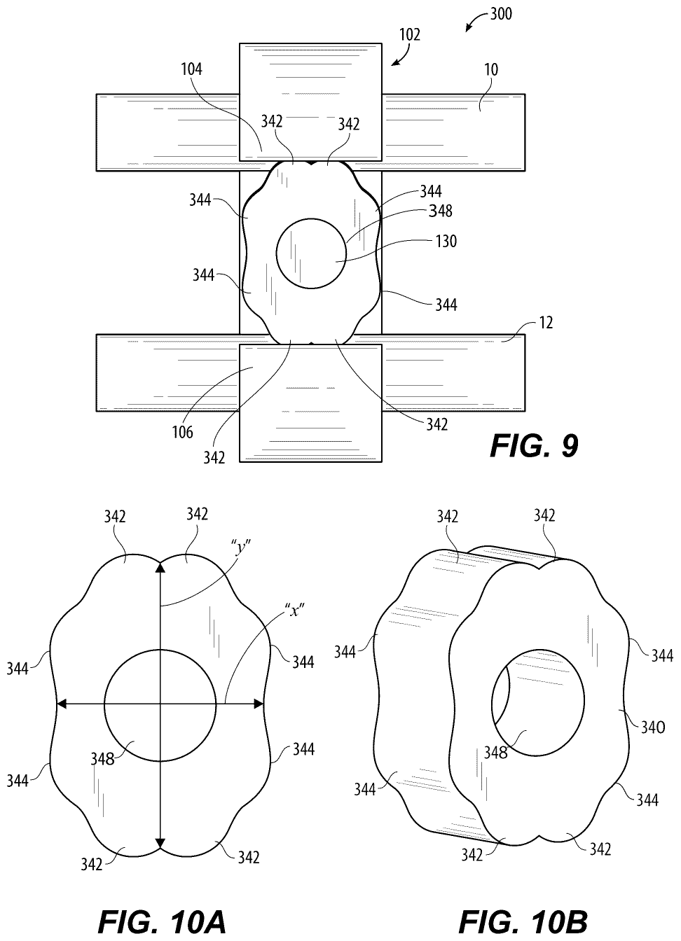

An electrical cable connector according to another illustrative embodiment of the present disclosure is shown in FIGS. 9, 10A and 10B and may be referred to generally as cable connector or connector 300. Connector 300 includes a C-shaped frame 102 which is similar to that described above with respect to FIGS. 1-6. For example, C-shaped frame 102 has an upper channel 104 and a lower channel 106 which extend from rear portion 109. Upper channel 104 and lower channel 106 are dimensioned for receiving stripped or bare cables 10 and 12, respectively, which are to be electrically and mechanically connected. Upper channel 104 and lower channel 106 may be dimensioned to receive cables of a particular size or gauge. Alternatively, upper channel 104 and lower channel 106 may be dimensioned to receive cables of various sizes or gauges. Connector 200 also includes a cam member 340 which is rotatably mounted by a pin 130 to the rear portion 109 s seen in FIG. 3 of C-shaped frame 102. Cam member 340 has an orifice 348 extending therethrough which is dimensioned to receive a portion of mounting pin 130 similar to the previously described embodiments.

Cam member 340 has a partial clover leaf shape and is wider in the “Y” direction than in the “X” direction as depicted in FIG. 10A. Cam member 340 is designed for securing cables having various diameters or gauges. For example, cables having a first diameter or gauge may be secured by rotating cam member 340 such that adjacent leaves 342 extending from cam member 340 are positioned extending up compressing cable 10 and extending down compressing cable 12, as depicted in FIG. 9. For connecting cables having a second diameter or gauge larger than the first diameter or gauge, cam member 340 can be rotated such that leaves 344 extending from cam member 340 are positioned extending up compressing cable 10 and extending down compressing cable 12. It will be appreciated that the outermost portions of adjacent leaves 342 together form a “flat” surface for the cables 10 and 12 to rest upon and prevent the cam member 340 from rotating out of position. Similarly, the outermost portions of adjacent leaves 342 together form a “flat” surface for the cables 10 and 12 to rest upon and prevent the cam member 340 from rotating out of position. In addition, adjacent leaves 342 and 344 may also together form a “flat” surface for the cables 10 and 12 to rest upon and prevent the cam member 340 from rotating out of position.

According to the present embodiment, in order to position cables within connector 300, cam member 340 is rotated so that leaves 344 of cam member 340 are positioned adjacent the upper and lower channels 104 and 106, respectively. The cables can then be easily placed within the upper channel 104 and lower channel 106 so that and the cam member 340 rotated in the appropriate clockwise or counterclockwise direction, depending on which of the leaves (342 and/or 344) are to be used to secure the cables 10 and 12.

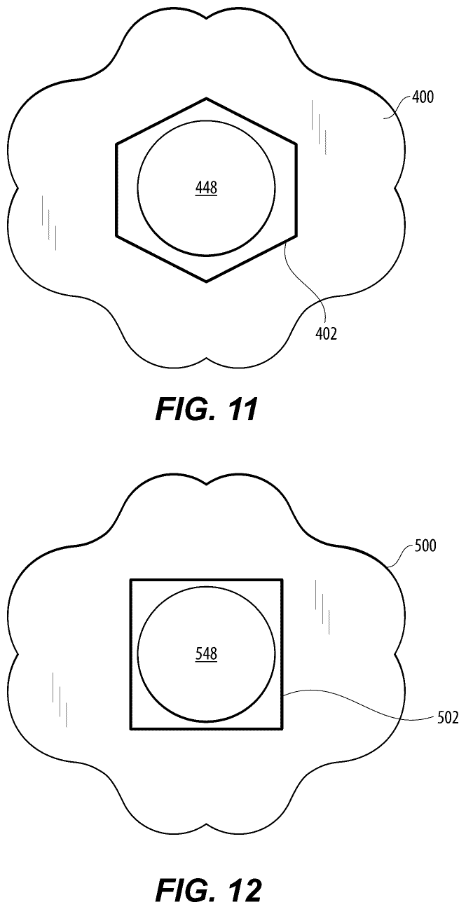

According to embodiments of the present of the present disclosure, structure may be provided on the connectors 100, 200, and/or 300 for assisting the user to rotate the cam member into the locking position utilizing ordinary common hand tools which may include, for example, a wrench, a pair of pliers or a socket wrench, etc. For example, as depicted in FIG. 11, the outside surface of cam member 400 may include a raised hexagonal structure 402 having an orifice 448. Hexagonal structure 402 may be dimensioned to receive an appropriately sized socket, box wrench, adjustable wrench or other suitable common tool. Utilizing an appropriate tool, the hexagonal structure 402 can assist the user in rotating the cam member 400 and compressing cables 10 and 12, within the connectors described herein. Of course, the raised structure 402 may be in any suitable configuration to receive a common tool which can be used to assist in rotating the cam member 400. For example, as depicted in FIG. 12, the outside surface of cam member 500 may include a raised square structure 502 having an orifice 548. Square structure 502 may be dimensioned to receive an appropriately sized box wrench, adjustable wrench or other suitable common tool. Utilizing an appropriate tool, the square structure can assist the user in rotating the cam member 500 and compressing the cables 10 and 12 within the connectors described herein. Other raised or recessed structures in various shapes and sizes for assisting in the rotation of the cam members are contemplated by the present disclosure

The C-shaped frames and cams may be made of an electrically conductive material that has sufficient rigidity to withstand the forces applied by the cam members against the C-shaped frames when mechanically and electrically connecting the first and second conductors. Non-limiting examples of such electrically conductive and rigid materials include aluminum, aluminum alloys, steel, stainless steel, galvanized steel, copper and copper/brass alloys, etc.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. An electrical cable connector assembly comprising:
a frame having opposing conductor securing contact sections; and
a cam member rotatably mounted to the frame between the opposing conductor securing contact sections,
wherein the cam member includes contact surfaces for contacting the conductors to be secured in the opposing conductor securing contact sections and when the cam member is rotated, the contact surfaces press against the conductors securing the conductors in the opposing conductor securing contact sections.

2. The electrical cable connector assembly according to claim 1, wherein the cam member comprises an oblong member.

3. The electrical cable connector assembly according to claim 1, wherein the cam member comprises a substantially clover shaped member.

4. The electrical cable connector assembly according to claim 2, wherein the cam member is configured having contact surfaces for securing conductors of various diameters or gauges.

5. The electrical cable connector assembly according to claim 2, wherein the cam member is rotatably mounted to the frame by a pin.

6. The electrical cable connector assembly according to claim 5, wherein the pin comprises at least three portions.

7. The electrical cable connector assembly according to claim 6, wherein a first portion of the pin comprises a proximal end section which tapers downward from a free to a start of a mid-section.

8. The electrical cable connector assembly according to claim 7, wherein the mid-section tapers upward to a distal end section.

9. The electrical cable connector assembly according to claim 8, wherein the distal end section is straight with no taper.

10. The electrical cable connector assembly according to claim 9, wherein the distal end section tapers from the mid-section to a free end.

11. The electrical cable connector assembly according to claim 9, wherein the distal end section tapers from a free end to the mid-section.

12. The electrical cable connector assembly according to claim 1, wherein the frame comprises a non-flat surface to which a surface of the cam member abuts.

13. The electrical cable connector assembly according to claim 12, wherein the non-flat surface comprises a lateral bump.

14. An electrical cable connector assembly comprising:
a substantially C-shaped frame having opposing conductor securing channels; and
a cam member rotatably mounted to the frame between the opposing conductor securing channels,
wherein the cam member includes contact surfaces for contacting the conductors to be secured in the opposing conductor securing channels and when the cam member is rotated, the contact surfaces press against the conductors securing the conductors in the opposing conductor securing channels.

15. The electrical cable connector assembly according to claim 14, wherein the cam member comprises an oblong member.

16. The electrical cable connector assembly according to claim 15, wherein the cam member comprises a substantially clover shaped member.

17. The electrical cable connector assembly according to claim 15, wherein the cam member is configured having contact surfaces for securing conductors of various diameters or gauges.

18. The electrical cable connector assembly according to claim 15, wherein the cam member is rotatably mounted to the frame by a pin.

19. The electrical cable connector assembly according to claim 18, wherein the pin comprises at least three portions.

20. The electrical cable connector assembly according to claim 19, wherein a first portion of the pin comprises a proximal end section which tapers downward from a free to a start of a mid-section.

21. The electrical cable connector assembly according to claim 20, wherein the mid-section tapers upward to a distal end section.

22. The electrical cable connector assembly according to claim 21, wherein the distal end section is straight with no taper.

23. The electrical cable connector assembly according to claim 22, wherein the distal end section tapers from the mid-section to a free end.

24. The electrical cable connector assembly according to claim 22, wherein the distal end section tapers from a free end to the mid-section.

25. The electrical cable connector assembly according to claim 14, wherein the frame comprises a non-flat surface to which a surface of the cam member abuts.

26. The electrical cable connector assembly according to claim 25, wherein the non-flat surface comprises a lateral bump.
